(19) United States
(12) Patent Application Publication
(10) Pub. No.: US 2013/0318579 A1
(43) Pub. Date: Nov. 28, 2013

(54) Method of Initiating Randomized Communication Links among Persons Belonging To an Organization by Executing Computer-Executable Instructions Stored On a Non-Transitory Computer-Readable Medium

(71) Applicant: Mala BROUGH, Fort Worth, TX (US)

(72) Inventor: Mala BROUGH, Fort Worth, TX (US)

(21) Appl. No.: 13/889,092

(22) Filed: May 7, 2013

Related U.S. Application Data
(60) Provisional application No. 61/650,356, filed on May 22, 2012.

(51) Int. Cl. G06F 17/30

(52) U.S. Cl. CPC G06F 17/30283; H04L 63/08
USPC 726/6; 707/758

(57) ABSTRACT

A method of initiating randomized communication links among persons belonging to an organization by executing computer-executable instructions stored on a non-transitory computer-readable medium allows members within an organization to submit requests to be engaged with other organization members for various activities such as eating or exercising. Engagement requests specify a time frame and a location to meet with other users. Engagement requests are time dependent and confined to a particular location. Engagements may be randomized, or prioritized for members who have not previously engaged with each other and filtered based on various other criteria.

The current application claims a priority to the U.S. Provisional Patent application Ser. No. 61/650,356 filed on May 22, 2012.

### FIELD OF THE INVENTION

The present invention relates generally to interpersonal engagements. More particularly, the present invention relates to a method for randomly initiating interpersonal engagements within an organization.

### BACKGROUND OF THE INVENTION

An interpersonal relationship is an association between two or more people that may range in duration from brief to enduring. This association may be based on inference, love, solidarity, regular business interactions, or some other type of social commitment. Interpersonal relationships are formed in a variety of contexts which can vary from family relations, friendship, marriage, associates, work, clubs, neighborhoods or other communal groups. Some interpersonal relationships are regulated by law, such as marriages or work relationships. Humans are a social species, and interpersonal relationships are the basis of social groups and the core unit of society as a whole.

Interpersonal relationships are dynamic systems that change continuously during their existence. Like living organisms, relationships have a beginning, a lifespan, and an end. One of the most influential models of relationship development was proposed by psychologist George Levinger. The model follows five stages: acquaintance, buildup, continuation, deterioration, and termination. This model was formulated to describe heterosexual, adult romantic relationships, but may be applied to almost any relationship, with various factors such as time frame or intensity during each stage varying among different types of relationships.

Forming interpersonal relationships in corporate work environments has been shown to yield many benefits for both employees and employers. Interpersonal relationships greatly influence an employee's development, build a sense of community within the workplace, and increase worker satisfaction and productivity. Although it behooves both employers and employees to cultivate interpersonal relationships between colleagues and coworkers, some work sites are more restrictive, or are deemed inappropriate for initiating casual interactions between coworkers. Such situations could exist as a result of small department sizes, inconsistent schedules, or even anti-fraternization policies. Additionally, some individuals may feel shy or feel uncomfortable approaching people. To mitigate these situations and promote a healthy corporate culture, many companies attempt to help employees interact through controlled social functions. Functions such as employee picnics and company parties are quite useful in helping individuals socialize, but generally occur infrequently and require massive amounts of planning and personal involvement. Additionally, when attending social functions people tend to socialize with other people they are already familiar with, which is not very helpful for building net interpersonal relationships.

It is therefore the object of the present invention to present a computerized method which aides in initiating communication links between individuals within an organization. The invention accomplishes this by providing a computerized system that accepts time sensitive meeting requests from individuals that are associated with the same organization. The invention aggregates the requests and randomly matches individuals who have similar time and location restrictions. The individuals would then meet up and the system would log the information for use with future engagement requests.

### BRIEF DESCRIPTION OF THE DRAWINGS

FIG. 1A is a stepwise flow diagram describing the overall method of the present invention.

FIG. 1B is a continuation of FIG. 1A which is a stepwise flow diagram describing the overall method of the present invention.

FIG. 2 is a stepwise flow diagram describing the process for managing organization profiles and locations.

FIG. 3 is a stepwise flow diagram describing various processes through which the administrator manages the organization profile.

FIG. 4 is a stepwise flow diagram describing various processes for allowing members to manage their accounts.

FIG. 5 is a stepwise flow diagram describing the process for matching engagement requests based on engagement criteria.

FIG. 6 is a stepwise flow diagram describing the process for selecting a successful engagement from multiple matching engagement requests.

FIG. 7 is a stepwise flow diagram describing the process for updating the engagement system database to reflect a successful engagement.

### DETAIL DESCRIPTIONS OF THE INVENTION

All illustrations of the drawings are for the purpose of describing selected versions of the present invention and are not intended to limit the scope of the present invention. There may be aspects of the present invention that may be practiced without the implementation of some features as they are described. It should be understood that some details have not been described in detail in order to not unnecessarily obscure focus of the present invention.

The present invention is a computerized method for initiating randomized time-sensitive engagements between individuals within an organization. In this context, randomized does not mean truly random, but determined by an algorithm that users are not made aware of, and so to the users the process appears to be random. An engagement refers to two or more individuals within the organization being arranged to meet for an activity, such as, but not limited to, a meal such as breakfast, lunch or dinner, going for a walk, jog or other exercise, playing a game, or any other activity that may be arranged between two or more individuals. The type of activity is determined by the users. In one embodiment, engagements may be arranged between more than two individuals and may be used to arrange group activities such as playing pickup sports games or yoga. Users submit engagement requests to the system and are matched for engagements based on various criteria. Engagements are time-sensitive, and are not guaranteed to be matched.

The present invention is primarily intended for use within a singular organization, such as, but not limited to, corporations, churches, LLCs, s-corp., 401(c) or any other organization that may benefit from utilizing the present invention. The present invention is primarily intended toward use in organizations with large memberships, such as approximately 200 or more members, but may also be used by organizations with smaller memberships. The present invention is also intended for users within relatively close physical proximity to each other, such as in the same building or campus. In an alternate embodiment, the present invention may be used among more than one organization; for example, if two or more organizations share the same building, engagements may be made between users of the two organizations, if the two organizations agree to cooperate using the present invention.

The preferred embodiment of the present invention is as a private network. For a given organization, members of the organization may only interact using the present invention with other members of the organization. Organizations may be provided with the option to allow non-members to interact with members using the present invention. Members preferably are granted access to the present invention by having an account created for the members by an administrator. In alternate embodiments, members may gain access to utilize the present invention by signing up with a particular email extension or being added to an email boundary list. In another alternate embodiment, members are provided with a network key or another type of access information that allows a member to access the present invention. This embodiment is intended for use in a non-permanent environment such as a conference.

An assortment of electronic networking components and programs such as, but not limited to, personal computers, servers, databases, and wired or wireless digital networks that allow the present invention to function may be referred to as an engagement system. In the preferred embodiment of the present invention, the engagement system is provided and managed by a central entity that provides the present invention as a service to organizations. An engagement system database is provided. The engagement system database contains any and all relevant data and programming code relevant to the present invention that allows the present invention to function properly, such as, but not limited to, past and present engagement data, member accounts, administrator accounts and data related to the member accounts and the administrator accounts. Specifically, the engagement system database comprises a plurality of current unfulfilled engagement (CUE) requests. Each of the plurality of CUE requests comprises a preferred location, a preferred time frame and a preferred activity.

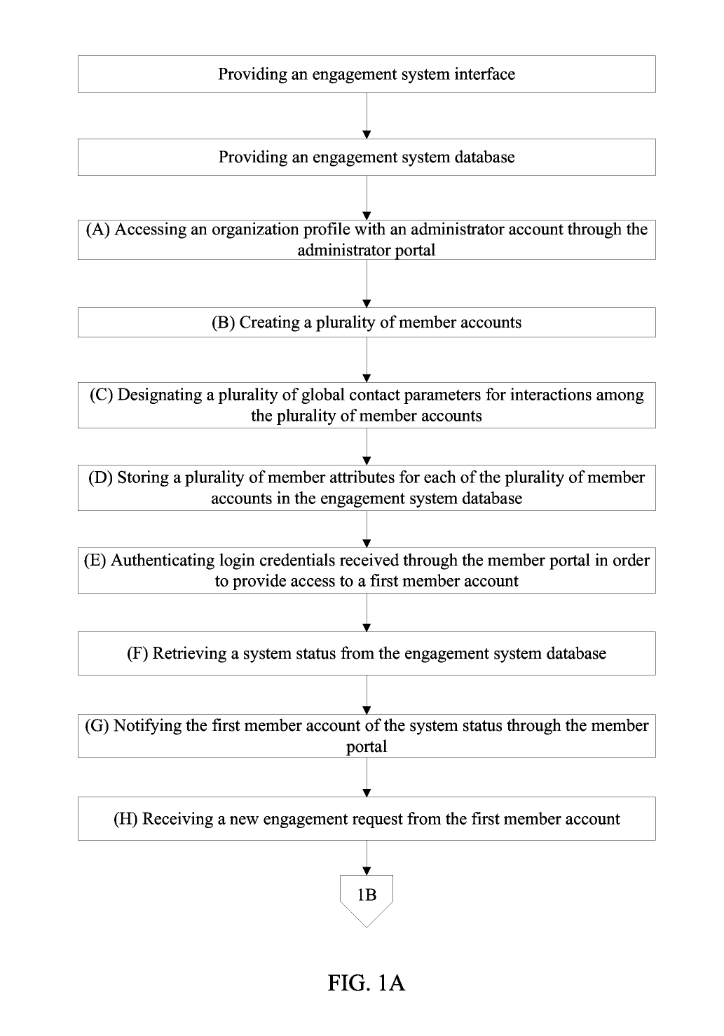

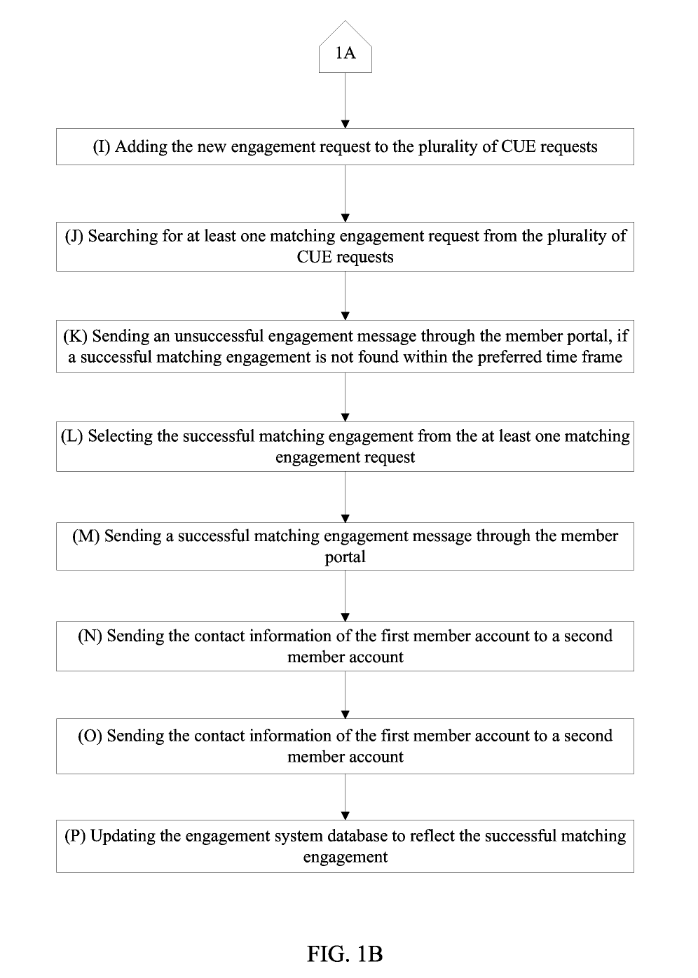

Referring to FIG. 1A, the engagement system database is accessed through an engagement system interface that is provided by the central entity so that organizations and users may utilize the present invention. The engagement system interface includes an administrator portal and a member portal. For each organization that registers with the engagement system, an administrator acts as a liaison between the organization and the engagement system. It should be understood that the administrator is associated with the organization, not the central entity providing the engagement system, and does not have access to back-end management features of the engagement system. The administrator utilizes an administrator account to access an organization profile in the engagement system through the administrator portal. Each organization comprises a plurality of members, each of whom has an account in the engagement system under the umbrella of the organization and who may access their respective accounts through the member portal.

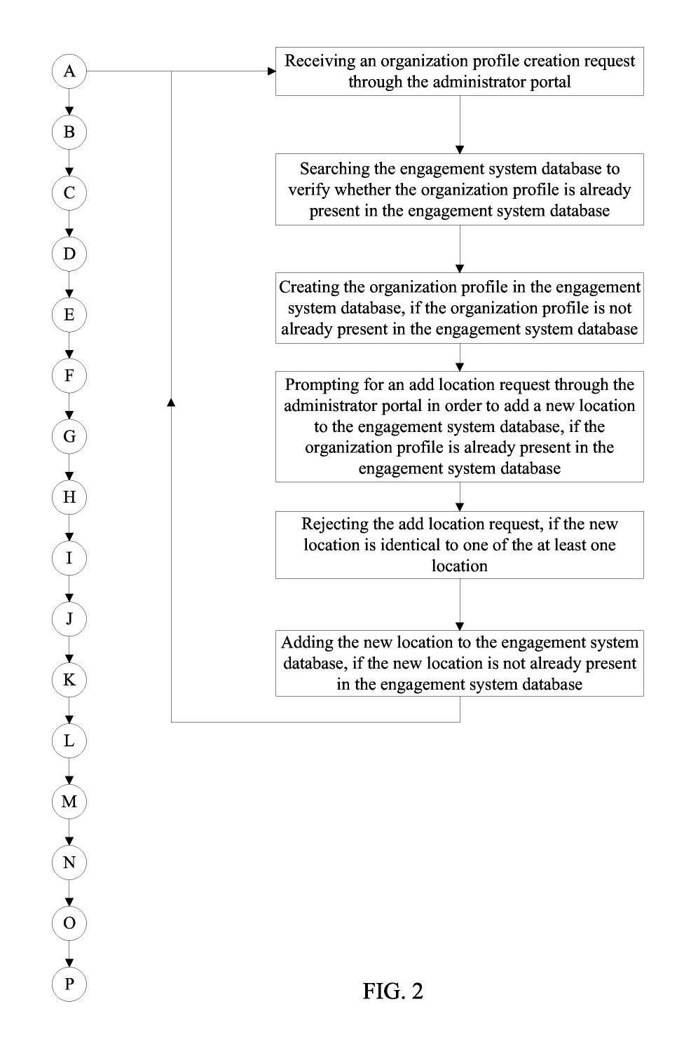

Referring to FIG. 2, when an organization registers with the engagement system, an organization profile creation request is received through the administrator portal. The engagement system database is then searched to verify whether the organization already has an organization profile present in the engagement system database. If the organization profile is already present in the engagement system database, the organization profile should be associated with at least one location. However, an organization may be able to utilize the present invention without specifying at least one location. If the organization has more than one branch or other locations, more than one location must be associated with the organization profile in order to allow engagements between members at the same location. However, engagements between members at different locations may be allowed if the different locations are in reasonable proximity. If the organization profile is not already present in the engagement system database, the organization profile is created in the engagement system database following the receipt of the organization profile creation request. If the organization profile is already present in the engagement system database, the administrator may be prompted for an add location request through the administrator portal in order to add a new location to the engagement system database. The administrator is also prompted for an add location request upon creating the organization profile. If the new location is identical to the at least one location, the add location request is rejected. If the new location is not already present in the engagement system database, the new location is added to the engagement system database.

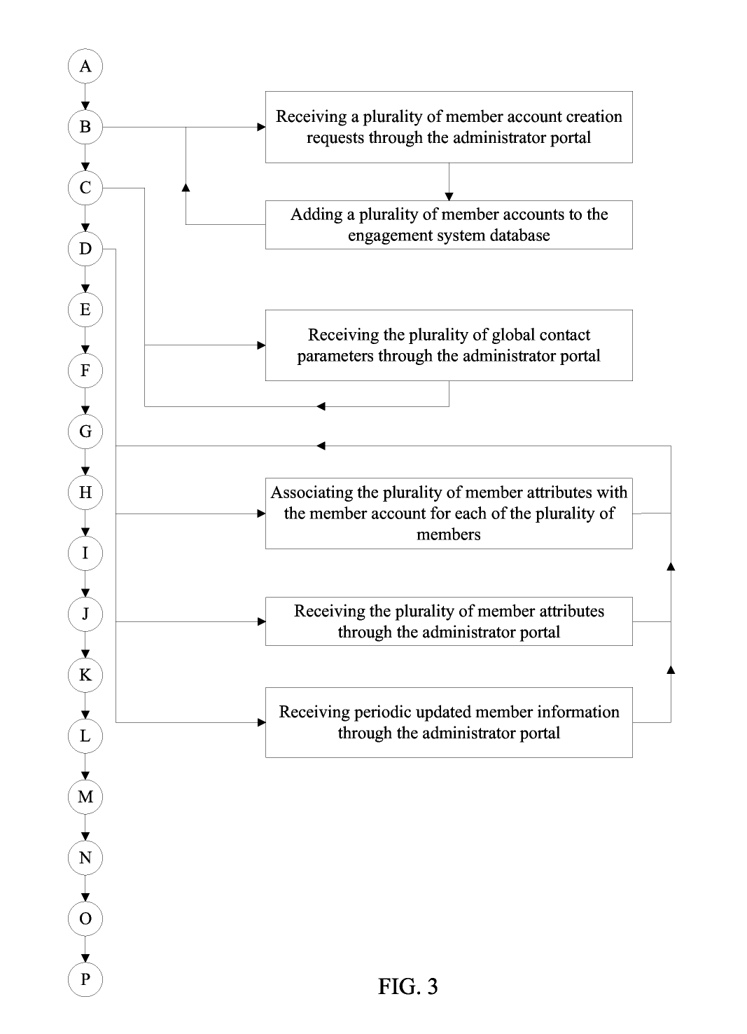

Referring to FIG. 3, the administrator may take a number of actions through the administrator portal. The administrator designates a plurality of global contact parameters for interactions among the plurality of member accounts, which are received by the engagement system through the administrator portal. The plurality of global contact parameters may preferably be created at the discretion of the administrator and include rules such as, but not limited to, prioritizing or restricting engagements to only among members of a certain rank within the organization, prioritizing or restricting engagements between married members, prioritizing or restricting engagements between members of differing departments, floors, buildings, or prioritizing or restricting engagements between newer and veteran employees or younger and older employees. In addition, the administrator periodically updates the organization account or member accounts in order to add new members or to remove members no longer with the organization. To this end, periodic updated member information is received through the administrator portal. The periodic updated member information includes new member account requests, remove member account requests and changes to the plurality of member attributes.

In the preferred embodiment of the present invention, the administrator also creates a plurality of member accounts that are associated with the organization profile. A member account is preferably created for each member in the organization. The engagement system receives a plurality of member account creation requests through the administrator portal in order to initiate the creation of the plurality of member accounts, and the plurality of member accounts are added to the engagement system database. Each of the plurality of member account creation requests corresponds to one of the plurality of member accounts. For each of the plurality of member accounts, the administrator submits a plurality of member attributes, and the plurality of member attributes is received through the administrator portal. The plurality of member attributes comprises, but is not limited to, login credentials, contact information and engagement history. Additionally, the plurality of member attributes may include the member's name, position, time with the organization, photo, email address, phone number, and location. The plurality of member attributes for each of the plurality of member accounts is stored in the engagement system database. The plurality of member attributes is associated with a corresponding member account for each of the plurality of members.

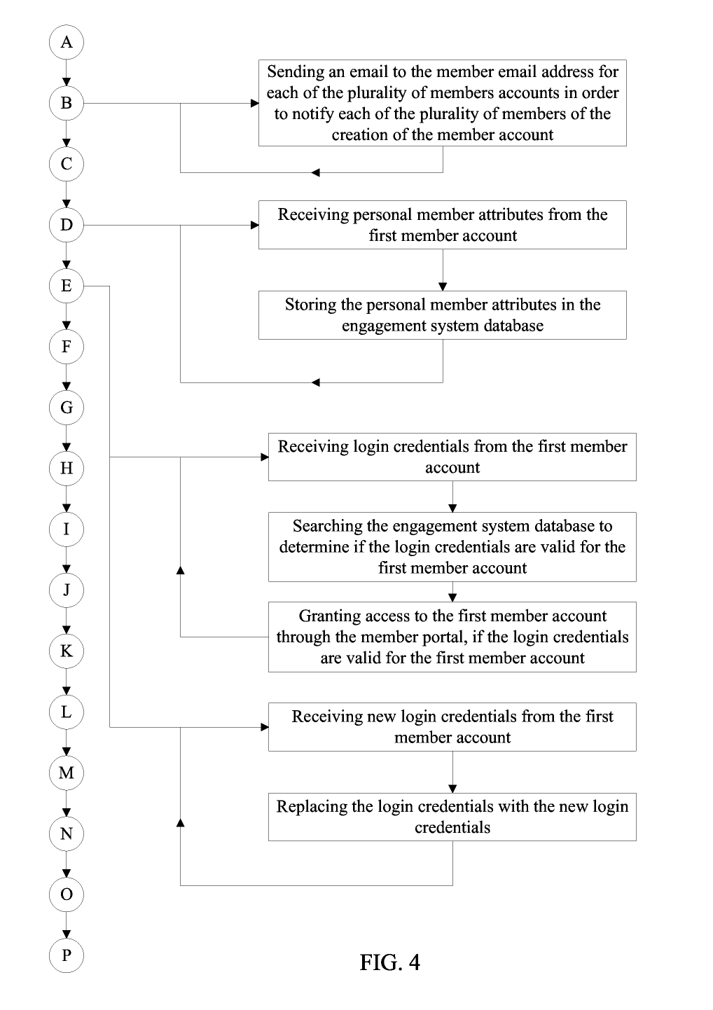

Referring to FIG. 4, a notification is sent to each of the contact information for the plurality of members in order to notify each of the plurality of members of the creation of the member account. To clarify the method, an example is presented from the perspective of a first member, who is one of the plurality of members. The same process applied to each of the plurality of members.

A first member account is created, and is associated with the first member. The first member account is created by the administrator through the administrator portal. Upon creation of the first member account, the first member is notified of the creation of the first member account, and is also notified of login credentials. The first time the first member accesses the engagement system through the member portal, the first member enters the login credentials, which are received by the engagement system from the first member account through the member portal. The login credentials are received through the member portal, and authenticated in order to provide access to the first member account. To authenticate the login credentials, the engagement system database is searched to determine if the login credentials are valid for the first member account. If the login credentials are valid for the first member account, access to the first member account is granted through the member portal. The first time the first member logs in, the first member is prompted to update their password and personal member attributes. To this end, new login credentials are received from the first member account and the login credentials are replaced with the new login credentials. The personal member attributes are additionally received from the first member account and are stored in the engagement system database. The engagement system is accessed through the member portal or administrator portal through a digital device, such as a smartphone, tablet, personal computer, or a web interface in an internet browser.

Upon accessing the first member account through the member portal, a system status is retrieved from the engagement system database. The system status comprises a CUE request count and the system status is sent through the member portal to the first member. To use the present invention, the first member selects a preferred time frame, a preferred location, and a preferred activity for a new engagement request. The preferred time frame may be defined in any appropriate manner designated by the administrator, such as, but not limited to, submitting a specific start and end time or choosing from a plurality of time blocks. The preferred location may be selected in any appropriate manner designated by the administrator, such as, but not limited to, selecting from one or more pre-defined locations, selecting an arbitrary point on a map, or specifying GPS coordinates. The preferred activity may be selected in any appropriate manner designated by the administrator, including, but not limited to, typing a word or plurality of words into a text box, or selecting from a list of pre-defined activities. The new engagement request is received by the engagement system from the first member account, and the new engagement request is added to the plurality of CUE requests.

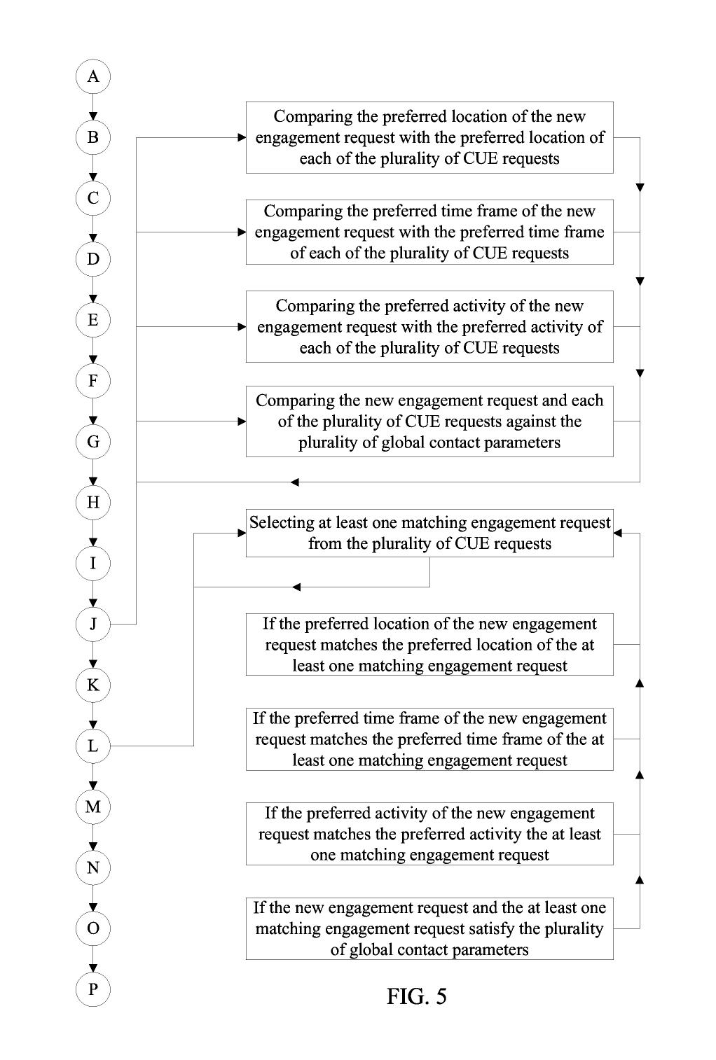

Referring to FIGS. 1B and 5, the engagement system searches through the engagement database for at least one matching engagement request from the plurality of CUE requests. The preferred location of the new engagement request is compared to the preferred location of each of the plurality of CUE requests, the preferred time frame of the new engagement request is compared to the preferred time frame of each of the plurality of CUE requests, the preferred activity of the new engagement request is compared to the preferred activity of each of the plurality of CUE requests, and the new engagement request and each of the plurality of CUE requests are compared against the plurality of global contact parameters. At least one matching engagement request is selected from the plurality of CUE requests, if the preferred location of the new engagement request matches the preferred location of the at least one matching engagement request, if the preferred time frame of the new engagement request matches the preferred time frame of the at least one matching engagement request, if the preferred activity of the new engagement request matches the preferred activity of the at least one matching engagement request, and if the new engagement request and the at least one matching engagement request satisfy the plurality of global contact parameters.

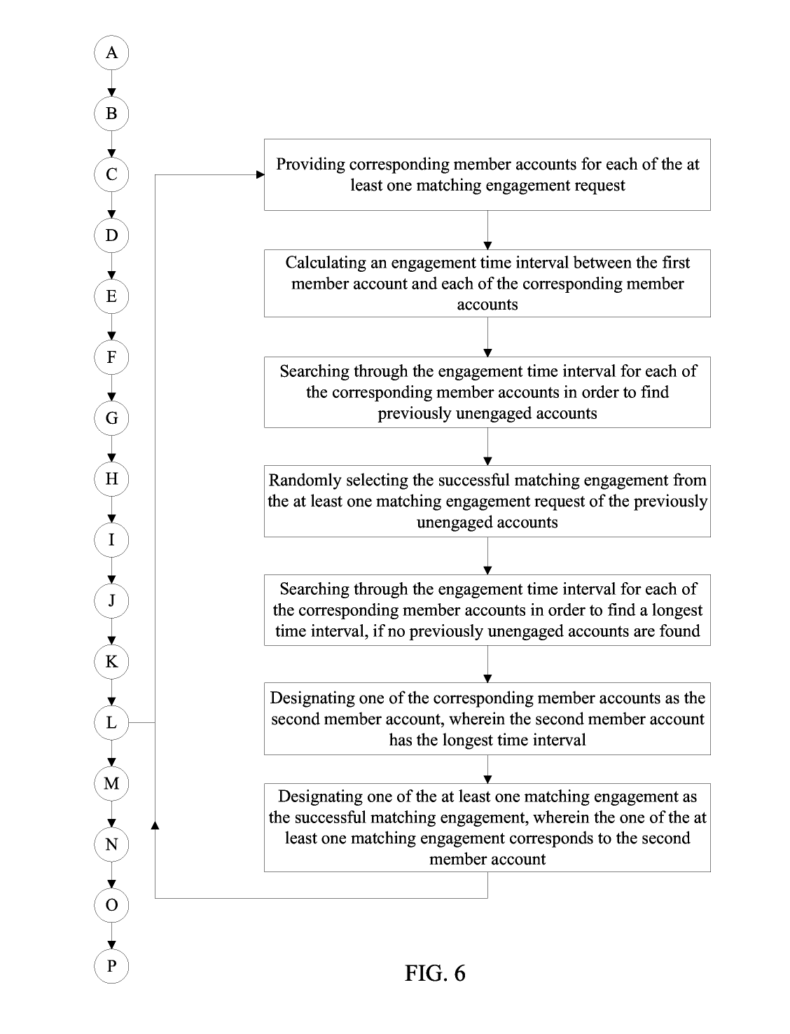

Referring to FIG. 6, corresponding member accounts are associated with each of the at least one matching engagement request. The following process is implemented in order to prioritize engagements between members who have not previously engaged or who have engaged the least recently. An engagement time interval is calculated between the first member account and each of the corresponding member accounts. The engagement time interval denotes time elapsed since a previous engagement between the first member account and each of the corresponding member accounts. In this disclosure, the engagement time interval is a plurality of time intervals, each of the plurality of time intervals being between the first member account and each of the corresponding member accounts. The engagement system searches through the engagement time interval for each of the corresponding member accounts in order to find previously unengaged accounts. An unengaged account is one of the corresponding member accounts that has never been matched with the first member account using the present invention. The engagement time interval for a previously unengaged account does not exist, is zero or is otherwise defined in a manner that denotes a previously unengaged account. If previously unengaged accounts are found, the successful matching engagement is randomly selected from the at least one matching engagement request of the previously unengaged accounts. To rephrase, if one or more member accounts are found to have never engaged with the first member account, the successful matching engagement is randomly selected from the at least one matching engagement request corresponding to the one or more member accounts that have never engaged with the first member account. The successful matching engagement is between the first member account and a second member account.

If no previously unengaged accounts are found, the engagement system searches through the time interval for each of the corresponding member accounts in order to find a longest time interval. One of the corresponding member accounts is designated as the second member account, since the second member account has the longest time interval. One of the at least one matching engagement is designated as the successful matching engagement, wherein the one of the at least one matching engagement corresponds to the second member account.

If the at least one matching engagement request is found, a successful matching engagement is selected from the at least one matching engagement request. The successful matching engagement meets a plurality of engagement criteria as described above. If a successful matching engagement is not found within the preferred time frame, an unsuccessful engagement message is sent to the first member through the member portal.

If the successful matching engagement is found, a successful matching engagement message is sent to the first member account and the second member account through the member portal, and the engagement system database is updated to reflect the successful matching engagement. The contact information of the first member account is send to the second member account, and the contact information of the second member account is sent to the first member account. In the preferred embodiment of the present invention, engagements may also be made with more than two members. Each member is able to select a group preference option associated with their engagement request. For example, if three members submit engagement requests with matching engagement criteria and all three members select the group preference option, all three members are connected for a group engagement.

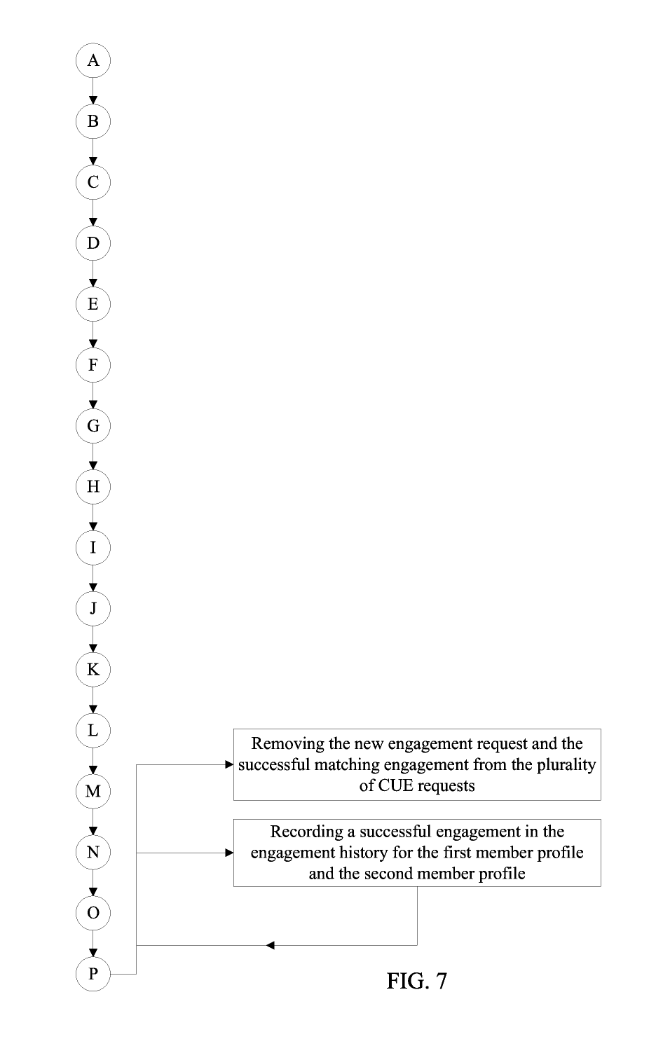

Referring to FIG. 7, if the successful matching engagement is found, the new engagement request and the successful matching engagement request are removed from the plurality of CUE requests, and a successful engagement is recorded in the engagement history for the first member profile and the second member profile.

Although the invention has been explained in relation to its preferred embodiment, it is to be understood that many other possible modifications and variations can be made without departing from the spirit and scope of the invention as hereinafter claimed.

What is claimed is:

1. A method of initiating randomized communication links among persons belonging to an organization by executing computer-executable instructions stored on a non-transitory computer-readable medium, the method comprises the steps of:
providing an engagement system interface, wherein the engagement system interface includes an administrator portal and a member portal;
providing an engagement system database,
wherein the engagement system database comprises a plurality of current unfulfilled engagement (CUE) requests;
wherein each of the plurality of CUE requests comprises a preferred location, a preferred time frame, and a preferred activity;
accessing an organization profile with an administrator account through the administrator portal;
creating a plurality of member accounts, wherein each of the plurality of member accounts is associated with the organization profile;
designating a plurality of global contact parameters for interactions among the plurality of member accounts;
storing a plurality of member attributes for each of the plurality of member accounts in the engagement system database, wherein the plurality of member attributes comprises login credentials, contact information and engagement history;
authenticating login credentials received through the member portal in order to provide access to a first member account;
retrieving a system status from the engagement system database, wherein the system status comprises a CUE request count;
notifying the first member account of the system status through the member portal;
receiving a new engagement request from the first member account;
adding the new engagement request to the plurality of CUE requests;
searching for at least one matching engagement request from the plurality of CUE requests;
sending an unsuccessful engagement message through the member portal, if a successful matching engagement is not found within the preferred time frame, wherein a successful matching engagement is selected from the at least one matching engagement request and meets a plurality of engagement criteria;
selecting the successful matching engagement from the at least one matching engagement request;
sending a successful matching engagement message through the member portal;
sending the contact information of the first member account to a second member account, wherein the successful matching engagement is between the first member account and the second member account;
sending the contact information of the second member account to the first member account;
updating the engagement system database to reflect the successful matching engagement;

2. The method of initiating randomized communication links among persons belonging to an organization by executing computer-executable instructions stored on a non-transitory computer-readable medium as claimed in claim 1 comprises the steps of:
receiving an organization profile creation request through the administrator portal;
searching the engagement system database to verify whether the organization profile is already present in the engagement system database, wherein the organization profile is associated with at least one location in the engagement system database if the organization profile is already present in the engagement system database;
creating the organization profile in the engagement system database, if the organization profile is not already present in the engagement system database;
prompting for an add location request through the administrator portal in order to add a new location to the engagement system database, if the organization profile is already present in the engagement system database;
rejecting the add location request, if the new location is identical to one of the at least one location;
adding the new location to the engagement system database, if the new location is not already present in the engagement system database;

3. The method of initiating randomized communication links among persons belonging to an organization by executing computer-executable instructions stored on a non-transitory computer-readable medium as claimed in claim 1 comprises the steps of:
receiving the plurality of member attributes through the administrator portal;
receiving the plurality of global contact parameters through the administrator portal;
receiving periodic updated member information through the administrator portal, wherein the periodic updated member information comprises new member account requests, remove member account requests and changes to the plurality of member attributes;

4. The method of initiating randomized communication links among persons belonging to an organization by executing computer-executable instructions stored on a non-transitory computer-readable medium as claimed in claim 1 comprises the steps of:
receiving a plurality of member account creation requests through the administrator portal;
adding a plurality of member accounts to the engagement system database, wherein each of the plurality of member accounts corresponds to one of the plurality of member account creation requests;
associating the plurality of member attributes with the member account for each of the plurality of members;

5. The method of initiating randomized communication links among persons belonging to an organization by executing computer-executable instructions stored on a non-transitory computer-readable medium as claimed in claim 1 comprises the steps of:
sending an email to the member email address for each of the plurality of members accounts in order to notify each of the plurality of members of the creation of the member account;
receiving login credentials from the first member account;
searching the engagement system database to determine if the login credentials are valid for the first member account;
granting access to the first member account through the member portal, if the login credentials are valid for the first member account;
receiving new login credentials from the first member account;
replacing the login credentials with the new login credentials;
receiving personal member attributes from the first member account;
storing the personal member attributes in the engagement system database;

6. The method of initiating randomized communication links among persons belonging to an organization by executing computer-executable instructions stored on a non-transitory computer-readable medium as claimed in claim 1 comprises the steps of:
comparing the preferred location of the new engagement request with the preferred location of each of the plurality of CUE requests;
comparing the preferred time frame of the new engagement request with the preferred time frame of each of the plurality of CUE requests;
comparing the preferred activity of the new engagement request with the preferred activity of each of the plurality of CUE requests;
comparing the new engagement request and each of the plurality of CUE requests against the plurality of global contact parameters;
selecting at least one matching engagement request from the plurality of CUE requests,
if the preferred location of the new engagement request matches the preferred location of the at least one matching engagement request, and
if the preferred time frame of the new engagement request matches the preferred time frame of the at least one matching engagement request, and
if the preferred activity of the new engagement request matches the preferred activity the at least one matching engagement request, and
if the new engagement request and the at least one matching engagement request satisfy the plurality of global contact parameters;

7. The method of initiating randomized communication links among persons belonging to an organization by executing computer-executable instructions stored on a non-transitory computer-readable medium as claimed in claim 1 comprises the steps of:
providing corresponding member accounts for each of the at least one matching engagement request;
calculating an engagement time interval between the first member account and each of the corresponding member accounts, wherein the engagement time interval denotes time elapsed since a previous engagement between the first member account and each of the corresponding member accounts;
searching through the engagement time interval for each of the corresponding member accounts in order to find previously unengaged accounts, wherein the engagement time interval for a previously unengaged account does not exist;
randomly selecting the successful matching engagement from the at least one matching engagement request of the previously unengaged accounts;
searching through the engagement time interval for each of the corresponding member accounts in order to find a longest time interval, if no previously unengaged accounts are found;
designating one of the corresponding member accounts as the second member account, wherein the second member account has the longest time interval;
designating one of the at least one matching engagement as the successful matching engagement, wherein the one of the at least one matching engagement corresponds to the second member account;

8. The method of initiating randomized communication links among persons belonging to an organization by executing computer-executable instructions stored on a non-transitory computer-readable medium as claimed in claim 1 comprises the steps of:
removing the new engagement request and the successful matching engagement from the plurality of CUE requests;
recording a successful engagement in the engagement history for the first member profile and the second member profile;
